(19) United States
(12) Patent Application Publication
(10) Pub. No.: US 2011/0116262 A1
(43) Pub. Date: May 19, 2011

(54) ECONOMICAL PARTIALLY COLLIMATING REFLECTIVE MICRO OPTICAL ARRAY

(75) Inventor: JONATHAN L. MARSON, HILLSBORO, OR (US)

(73) Assignee: PHOSEON TECHNOLOGY, INC., Hillsboro, OR (US)

(21) Appl. No.: 12/618,688

(22) Filed: Nov. 13, 2009

(51) Int. Cl. F21V 7/00; B29D 11/00

(52) U.S. Cl. 362/235; 264/1.9; 313/504

(57) ABSTRACT

A lighting module has an array of light emitting elements arranged on a substrate in an x-y grid, and a reflector plate arranged on the substrate, the reflector plate having an array of openings arranged on an x-y grid such that the openings correspond to the light emitting elements, the dimensions of the reflector plate and the openings arranged to partially collimate light from the light emitting elements. A method of manufacturing a lighting module includes arranging an array of light emitting elements on a substrate, manufacturing a reflector plate having an array of openings, the openings located so as to correspond to the light emitting elements and created so as to only partially collimate light from the light emitting elements, and attaching the reflector plate to the substrate such that each opening in the reflector plate is centered on a light emitting element.

### BACKGROUND

Ultraviolet (UV) curing has many applications in printing, coating and sterilization. UV-sensitive materials generally rely upon a particular amount of energy in the form of UV light to initiate and sustain the curing process (polymerization) within the materials. UV light fixtures, commonly known as UV lamps, provide the UV light to the materials for curing.

Using arrays of light emitting diodes (LEDs) in UV curing has several advantages over using arc lamps, including lower power consumption, lower cost, cooler operating temperatures, etc. Generally, the arrays consist of individual LED elements arranged in an X-Y grid on a substrate. The goal of the array is to deliver UV light to a target work surface at a given distance from the array with high irradiance and low variation in irradiance throughout the illuminated area at the work surface. The LEDs are diffuse point sources, which leads to uniform illumination at a given distance. However, at this distance, the irradiance falls to a level that is not sufficient to achieve the desired degree of polymerization. The challenge is to increase the irradiance at the target distance without increasing the variation in the irradiance pattern at the work surface to a level that causes non-uniform polymerization at the target.

Marshall et. al. teach “LED Collimation optics with improved performance and reduced size” in U.S. Pat. No. 6,547,423, issued Apr. 15, 2003. There are some problems with this design when applied to the field of UV Curing. The size of the optic severely limits the number of modules that can be placed in one square centimeter which significantly reduces the irradiance that the plurality of modules can deliver to a work surface. The second problem is that the design substantially collimates the light emitted from the module. When a plurality of modules is used to deliver the maximum irradiance to a work surface—the resulting irradiance pattern has significant variation which results in non-uniform polymerization at the work surface. The third problem is manufacturing a plurality of modules. The optic is relatively complex to design and manufacture. The optic is also relatively expensive, which affects the overall cost of the luminaire and potential markets for such a device.

Another approach achieving a high degree of collimation is shown in U.S. Pat. No. 4,767,172, issued Aug. 30, 1988. This approach has the same drawbacks in the field of UV curing as stated above. Another design that considers only a single light source is shown in U.S. Pat. No. 6,190,020, issued Feb. 20, 2001 which also suffers from the same limitations listed above.

In addition, the highly collimating approaches may actually prove to cause problems with the LED light fixtures used in certain applications. If the light is too highly collimated, it will result in regions of too much illumination, ‘hot spots,’ at the target, an undesirable result.

### BRIEF DESCRIPTION OF THE DRAWINGS

FIG. 1 shows an embodiment of a lighting module having a reflector plate.

FIG. 2 shows a top view of an embodiment of a lighting module having a reflector plate.

FIG. 3 shows a side view of an embodiment of a lighting module having a reflector plate.

FIG. 4 shows a side view of an embodiment of a lighting module having a reflector plate with an optical element.

FIG. 5 shows a side view of an alternative embodiment of a lighting module having a reflector plate with an optical element.

### DETAILED DESCRIPTION OF THE EMBODIMENTS

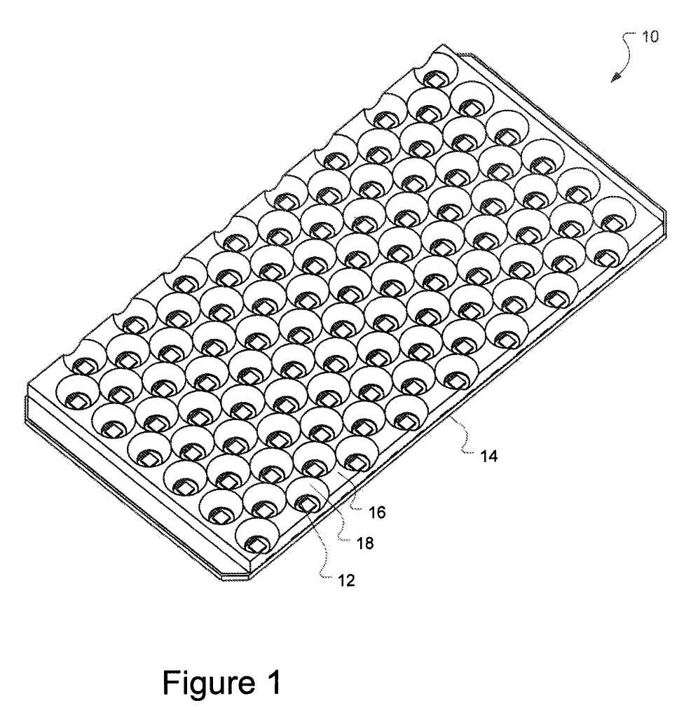

FIG. 1 shows a perspective view of a lighting module 10. The lighting module 10 includes a substrate 14 upon which individual light emitting elements 12 are arranged in an x-y grid. Examples of individual light emitting elements include light emitting diodes, including organic light emitting diodes (OLEDs). Generally, these light emitting elements are arranged on the substrate with the appropriate lines to provide power and control of the elements.

A reflector plate 16 is then attached to the substrate 14. The reflector plate 16 is a material which has an array of openings such as 18 that act as reflector cups for each light emitting element 12. The array of openings is arranged so that there is one opening for each light emitting element. Generally, the reflector plate is manufactured so the light emitting elements are centered in each opening and the shape of the opening is controlled to achieve the desired modification to the emission pattern of light from the light emitting element.

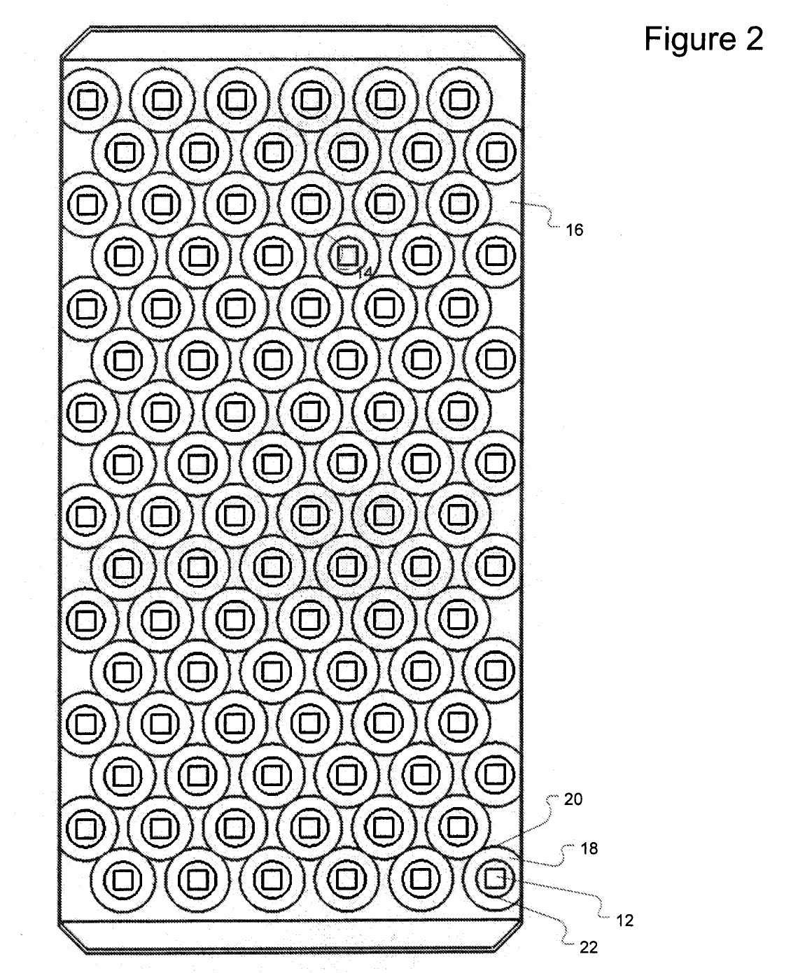

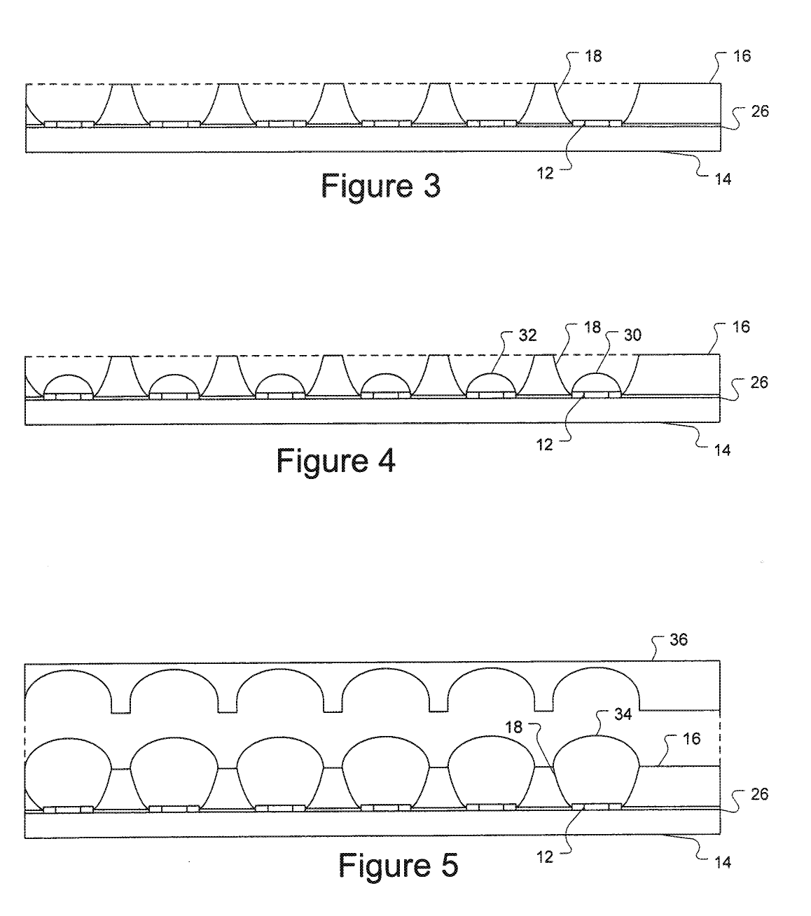

FIG. 2 shows a top view of the reflector plate 16. The openings in the reflector plate such as 18 will generally center on the individual light emitting elements such as 12. As shown in more detail in FIGS. 3-5, the openings penetrate through the reflector plate, having a first aperture 22 at the bottom surface of the reflector plate and a wider, second aperture 20 at the top of the reflector plate.

In this embodiment, the bottom of the reflector plate is oriented to contact the surface of the substrate 14 of FIG. 1. Further, the ‘surface’ of the substrate may actually be a coating or other covering on the substrate 14 that protects the electrical lines for the light emitting elements. This is not meant to limit the scope of the invention to a reflector plate in contact with the substrate. The reflector plate can also be offset from the substrate at a given height such that the plate is no longer in contact with the substrate while still achieving the desired optical transformation. This offset can be achieved in many ways. Once such way is using electrically isolating standoffs which are attached to the substrate and the reflector plate but, there are many obvious and logical ways to achieve this standoff as someone skilled in the art will readily perceive.

FIGS. 3-5 show cross-sectional views of a lighting module such as that shown in FIG. 1 of alternative embodiments of the reflector plate 16. As shown in side view of FIG. 3, the reflector plate may appear to have a line at the top of each opening such as shown for opening 18. For purposes of better understanding of the discussion, FIGS. 3-4 show this as a dashed line. As mentioned previously, the reference to the reflector plate being attached to, residing on or adjacent to the substrate 14 may include the reflector plate resting or contacting a wiring layer 26 that contains the electrical connections lines for the light emitting elements such as 12. The openings such as 18 act to partially collimate the light from the light emitting element 12. The openings partially collimate the light purposefully, rather than substantially collimating the light. The intended light output should have good uniformity at a target distance, and collimating the light substantially will result in hot spots at the target. The hot spots would correspond to the locations of the light emitting elements in the lighting fixture The optical element required to substantially collimate the light emitted from the light emitting element would also increase the diameter of the openings 18 which in turn affect the minimum spacing of the light emitting elements arrayed on the substrate. This is the trade off that is required in the field of UV curing with light emitting elements. Maximize irradiance at a given distance while maintaining good uniformity.

Dimensionally, achieving partial collimation may occur by controlling the depth of the reflector plate 16, and consequently the depth of the openings. If one wanted near full collimation of the light, the reflector plate may have a height of a particular measure. To achieve partial collimation, one can reduce the height of the reflector plate to about half the height that would attain near full collimation. This may be in terms of the cone angle of the reflector cup.

In another dimension, one can consider the dimensions of the light emitting element. For example, if the light emitting element is 1 millimeter wide, the opening may be 2 millimeters wide or having a proportion that is twice that of the light emitting elements. The openings are proportional to the light emitting elements, with no limitation as to the range of the resulting dimension. This may also be referred to as the openings being on the order of a dimension of the light emitting elements

In an alternative embodiment, a micro lens or other optical element may be included in the lighting module, typically one optical element per light emitting element. FIG. 4 shows an array of lens elements consisting of lenses such as 30 and 32, across the array of light emitting elements. In this embodiment, the lens material, such as an optically transparent gel, would be deposited on the individual light emitting elements prior to the attachment of the reflector plate. In one example, the gel is dispensed as drops on the light emitting elements, which then harden or are cured into lens elements

In another embodiment of FIG. 4, the lens material may be deposited or formed after the attachment of the reflector plate.

In another embodiment, shown in FIG. 5, the lens elements 34 extend beyond the openings such as 18 in the reflector plate. In this instance, the lens material 34 may be molded by a mold 36. In this embodiment, the reflector plate 16 is attached to the substrate 14 and the lens material deposited into the openings. The deposit may occur after the mold 36 is also attached, in which case the side of the mold 36 opposite the reflector plate would also having openings. Alternatively, the material may be deposited and then a mold applied. In either embodiment, the optical elements such as 34 would extend beyond the opening 18 in the reflector plate.

The use of a reflector cup may provide some benefits in manufacturing the optical elements, as well as increasing the overall efficiency of the lighting module. In the above embodiment, the reflector cup also acts as a partial mold for the lower portion of the lens material.

The resulting lighting module, with or without lenses, provides a uniform light with relatively high irradiance to the work surface. The uniformity is typically quantified as having less than thirty percent difference between the maximum and minimum irradiance over the illuminated area, and the intensity is typically greater than one Watt per square centimeter over the illuminated area. The reflector plate is easily manufacturable, scales to the size needed for two-dimensional arrays of lighting elements and maintains a relatively short height, allowing it to fit into current lighting module fixtures.

Thus, although there has been described to this point a particular embodiment for a method and apparatus for a reflector plate, it is not intended that such specific references be considered as limitations upon the scope of this invention except in-so-far as set forth in the following claims.

What is claimed is:

1. A lighting module, comprising:
an array of light emitting elements arranged on a substrate in an x-y grid; and
a reflector plate arranged on the substrate, the reflector plate having an array of openings arranged on an x-y grid such that the openings correspond to the light emitting elements, the dimensions of the reflector plate and the openings arranged to partially collimate light from the light emitting elements.

2. The lighting module of claim 1, wherein the array of light emitting elements comprises light emitting diodes or organic light emitting diodes.

3. The lighting module of claim 1, further comprising an array of lens elements arranged such that each lens in the array is arranged in one of the openings in the array of openings of the reflector plate.

4. The lighting module of claim 3, wherein the array of lens elements are arranged to be contained within the openings in the reflector plate.

5. The lighting module of claim 3, wherein the array of lens elements are arranged so as to extend beyond the openings in the reflector plate.

6. The lighting module of claim 1, wherein the openings have dimensions selected to provide uniform illumination from the light emitting elements at a target distance.

7. The lighting module of claim 1, wherein the reflector plate comprises one of an injection molded structure having a reflective coating, or a metal plate having machined openings.

8. The lighting module of claim 1, wherein the openings have dimensions on the order of a dimension of the individual lighting elements.

9. The lighting module of claim 8, wherein the reflector plate has a height approximately half a height that would collimate substantially all of the light.

10. A method of manufacturing a lighting module, comprising:
arranging an array of light emitting elements on a substrate;
manufacturing a reflector plate having an array of openings, the openings located so as to correspond to the light emitting elements and created so as to only partially collimate light from the light emitting elements; and
attaching the reflector plate to the substrate such that each opening in the reflector plate is centered on a light emitting element.

11. The method of claim 10, wherein manufacturing a reflector plate comprises one of either forming the reflector plate by injection molding and then coating the plate with a reflective coating, or machining the openings into a piece of metal.

12. The method of claim 10, the method further comprising arranging a lens element over each light emitting element.

13. The method of claim 12, wherein arranging a lens element comprises forming a lens over each light emitting element comprising depositing a lens material over each light emitting element prior to attaching the reflector plate.

14. The method of claim 12, wherein arranging a lens element comprises:
attaching a mold to the reflector plate;
depositing lens material into each opening of the reflector plate through the mold; and
removing the mold after the lens material hardens.

15. The method of claim 12, wherein arranging a lens element comprises:
depositing lens material into each opening with excess material on the reflector plate;
a mold then placed on the excess material forming the lens; and
removing the mold after the lens material hardens.

16. The method of claim 10, wherein manufacturing the reflector plate comprises manufacturing a reflector plate having a height approximately half a height that would cause the openings to collimate substantially all of the light from the light emitting elements.

17. The method of claim 10, wherein manufacturing the reflector plate comprises forming the openings with dimensions such that the openings only partially collimate the light from each light emitting element.
